(19) United States
(12) Patent Application Publication
(10) Pub. No.: US 2012/0132799 A1
(43) Pub. Date: May 31, 2012

(54) Mass Spectrometer

(75) Inventors: Kazuteru Takahashi, Uji-shi (JP); Kiyoshi Ogawa, Kizugawa (JP); Mitsutoshi Setou, Hamamatsu-shi (JP)

(73) Assignee: SHIMADZU CORPORATION, Kyoto-shi, Kyoto (JP)

(21) Appl. No.: 13/260,061

(22) PCT Filed: Mar. 31, 2009
(86) PCT No.: PCT/JP2009/001493

§ 371 Date: Nov. 8, 2011

(51) Int. Cl. H01J 49/26

(52) U.S. Cl. 250/288

(57) ABSTRACT

A samples stage (2) on which a sample (4) is placed can reciprocally move along a guide (5) by a driving mechanism. An image taken by an imaging unit (7) when the sample stage (2) is at an observation position (A) is processed by an image processor (34) and is displayed on a window of a display unit (38). When an analysis operator specifies a measurement area by an operation unit (37), a controller (3) moves, through a stage driver (33), the stage (2) to a sample operation position (B) and a matrix is applied to the specified measurement area by an ejector (9). After that, the stage (2) is moved to an analysis position (C) and a laser light is delivered onto the measurement area on the sample (4) to which the matrix was applied, and the ionization by the MALDI method is performed. This eliminates the need to take out the sample from the apparatus to apply the matrix after the measurement point or measurement area is determined based on a microscopic observation of the sample. Accordingly, the efficiency of the measurement can be increased, and since no positional error of the sample occurs, it is possible to perform an imaging mass analysis for a measurement area of interest with high positional accuracy.

### TECHNICAL FIELD

The present invention relates to a mass spectrometer. More specifically, it relates to a mass spectrometer, called a mass microscope or an imaging mass spectrometer, capable of performing a mass analysis for a two-dimensional area on a sample.

### BACKGROUND ART

In order to observe the morphology of a sample such as a biological tissue and simultaneously measure the distribution of the molecules existing in a specified area on the sample, apparatuses called a mass microscope or an imaging mass spectrometer have been developed (refer to Patent Documents 1 and 2, Non-Patent Documents 1 and 2, and other documents). These apparatuses require no grinding or crushing of the sample as required in conventional apparatuses and hence are capable of mapping molecules included in any area on the sample specified based on a microscopic observation while almost completely maintaining the original morphology of the sample. These apparatuses are expected to be used, for example, to obtain distribution information on the proteins included in a living cell, particularly in the fields of biochemistry, medical care, pharmaceutical chemistry, and other fields.

In the mass microscope described in Non-Patent Documents 1 and 2 for example, a sample stage on which a sample is placed can be moved between a microscopic observation position and an analysis position where an ionization is performed by a matrix-assisted laser desorption ionization (MALDI) method. The analysis is performed by the following procedure.

A sample (e.g. a slice of a biological tissue cut off from a living organism) is first placed on the sample stage, and then a magnified image of the sample surface is taken by a microscope apparatus or the sample surface is directly observed with an optical microscope to determine a measurement point or a measurement area on the sample. After that, the sample is taken out from the apparatus to apply or spray a matrix onto the sample surface, and is placed on the sample stage once again. The reason why a matrix is attached after the measurement point or measurement area is once determined is because application of a matrix can hide a detailed shape or color on the sample surface, making it difficult to find an appropriate measurement position. Then, the sample stage is moved to the analysis position, and a mass analysis is performed for the set measurement point or measurement area.

In the case where a mass analysis is performed for one point (minute area) for example, a laser light with a micro-narrowed diameter is delivered onto the minute area, and ions generated in response to the irradiation are introduced into a time-of-flight mass spectrometer and mass analyzed. In the case where a mass analysis is performed for a two-dimensional measurement area, the sample stage is moved so as to scan (e.g. raster scan) the measurement area with the laser light having a micro-narrowed diameter. The mass analysis is sequentially performed for different minute areas to collect distribution information.
[Patent Document 1] JP-A 2007-66533
[Patent Document 2] JP-A 2007-157353
[Non-Patent Document 1] Kiyoshi Ogawa and five other authors, “Kenbi Shitsuryo Bunseki Sochi no Kaihatsu,” (“Research and Development of Mass Microscope”) Shimadzu Review, Shimadzu Corporation, Mar. 31, 2006, vol. 62, nos. 3-4, pp. 125-135
[Non-Patent Document 2] Takahiro Harada and eight other authors, “Kenbi Shitsuryo Bunseki Sochi ni yoru Seitai Soshiki Bunseki,” (“Biological Tissue Analysis using Mass Microscope”) Shimadzu Review, Shimadzu Corporation, Apr. 24, 2008, vol. 64, nos. 3•4, pp. 139-146

### DISCLOSURE OF THE INVENTION

### Problems to be Solved by the Invention

As previously described, in conventional mass microscopes, after a sample is set on the sample stage and the sample surface is microscopically observed, it is necessary to take out the sample to perform a pretreatment such as an application of a matrix and then set the sample on the sample stage once again. That is, the operation procedure is not efficient, and it is hence difficult to enhance the throughput of the analysis. In addition, when the sample is taken out and set again on the sample stage, a positional error of the sample may occur, which impedes an accurate analysis for the initially determined measurement point or measurement area. Further, after an analysis, it is difficult to locate the accurate measurement point or measurement area for which the mass analysis was actually performed.

In order to prevent such a positional error, the measurement point or measurement area should be determined by a microscopic observation with a matrix attached onto the sample surface. However, since the application of the matrix hides the microscopic shape and blurs the color on the sample, it is difficult to determine a position or area for which an analysis operator wants to analyze. Furthermore, it is almost impossible to locally apply a matrix only to the vicinity of the measurement point or measurement area which was determined based on the microscopic observation of the sample surface. Hence, it is also difficult to check the analysis result for a measurement point or measurement area and perform an analysis again after a new measurement point or measurement area is set which is different from that in the previous measurement or after the conditions of applying the matrix are changed.

The present invention has been developed in view of the aforementioned problems, and the main objective thereof is to provide a mass spectrometer capable of, after the position of the area for which a mass analysis is performed is determined based on a microscopic observation of a sample surface, performing a pretreatment necessary for the analysis such as an application of matrix without removing the sample from the apparatus, and then continuing the analysis.

### Means for Solving the Problems

To solve the aforementioned problems, the present invention provides a mass spectrometer including:

a) a sample holder for holding a sample;

b) an observation unit for observing a surface of the sample held by the sample holder;

c) an ionization unit for ionizing a component at a specified position on the sample held by the sample holder;

d) a mass analyzer for mass analyzing an ion generated by the ionization unit;

e) a pretreatment unit for performing a pretreatment operation, to the sample, for making the sample held by the sample holder ready to be ionized by the ionization unit; and

f) a moving unit for moving the sample holder in such a manner that the sample is sequentially carried to an observation position where the sample can be observed by the observation unit, a sample operation position where the pretreatment operation can be performed, and an analysis position where an ionization can be performed by the ionization unit.

Typically, the ionization unit is a device for emitting a laser light with a micro diameter for ionization by the MALDI method. However, a variety of laser desorption ionization (LDI) methods may be used other than the MALDI method. An ionization method which does not use a laser light may also be used such as a desorption electrospray ionization (DESI) method or a secondary ion mass spectrometry method.

In the case where the ionization unit performs an ionization by the MALDI method, the pretreatment unit may perform a pretreatment operation in which a matrix is applied to the surface of the sample. In the case where the sample is protein, the pretreatment unit may perform a pretreatment operation in which a digestive enzyme is applied to the sample. The pretreatment unit may perform a plurality of pretreatment operations: for example, applying a digestive enzyme to the sample surface and then applying a matrix thereto.

In the mass spectrometer according to the present invention, with a sample set on a sample holder such as a sample stage, the position of the sample is sequentially moved from the observation position, through the sample operation position, to the analysis position. At these positions, the following operation is sequentially performed: an observation of the sample surface and the determination of the measurement area based on the observation; an application of a matrix to the measurement area; and a mass analysis for the measurement area. Accordingly, there is no need to take out the sample from the sample holder after the measurement point or measurement area is determined based on the observation of the sample. The observation unit may be designed to perform a magnifying observation or a microscopic observation.

In particular, the mass spectrometer according to the present invention may preferably further include:

g) a specifier for specifying a position or area for which a mass analysis is performed on a sample surface image observed by the observation unit; and

h) a controller for controlling the moving unit in such a manner that the pretreatment operation is performed for the measurement point or measurement area on the sample specified by the specifier and that the position or area is mass analyzed.

In performing an analysis by using the mass spectrometer according to the present invention, an analysis operator sets a sample to be analyzed on a sample holder such as a sample stage. Then, the sample holder is first moved by the moving unit under the control of the controller, so that the sample comes to the observation position for the observation unit. In this state, an image of the whole or a portion of the sample surface can be obtained by the observation unit. Then, while visually checking the image, the analysis operator specifies, through the specifier, a measurement point of interest or a one-dimensional or two-dimensional measurement area of interest. When the measurement point or the analysis area is determined, the sample holder is moved by the moving unit under the control of the controller, so that the sample comes to the sample operation position for the pretreatment unit.

For example, the pretreatment unit drops or sprays a matrix onto the sample so that the matrix is attached to the measurement point or measurement area previously specified by the analysis operator. When the analysis operator specifies a measurement point or measurement area on a sample surface image by using a specifier, the measurement point or measurement area can be obtained as position (coordinate) information of the sample holder for example. Hence, the controller uses the position information to control the moving unit in such a manner that the predetermined position in the sample is accurately located at the position where an operation is performed by the pretreatment unit. Accordingly, the pretreatment unit can apply a matrix to the specified measurement point or measurement area with high positional accuracy. In other words, no matrix is applied to the area other than the specified measurement point or measurement; in such an area, the sample surface remains exposed.

The sample holder is moved again by the moving unit under the control of the controller so as to carry the sample with the matrix applied to its surface to the analysis position. Then, a laser light is delivered from the ionization unit to the measurement point which was specified by the analysis operator based on the image of the sample surface previously obtained by observation. In the case where a one-dimensional or two-dimensional measurement area was specified, the point onto which the laser light is delivered is moved so as to scan that area. Since the position information obtained when the measurement point or measurement area was specified is used also for such a laser irradiation, the laser light can be delivered to the measurement point or measurement area of interest with high positional accuracy.

At the point onto which the laser light is delivered, components in the sample are ionized, and the generated ions are introduced into the mass analyzer. There are a variety of methods available for separating ions in accordance with their mass-to-charge ratio (m/z) in the mass analyzer. In order to achieve a high mass resolving power, a time-of-flight type mass analyzer may be preferably used.

As previously described, in the mass spectrometer according to the present invention, the following operation is sequentially performed with the sample set on the sample holder: an observation of the sample surface and a determination of the measurement area based on the observation; an application of a matrix to the measurement area; and a mass analysis for the measurement area. Further, it is also possible to move the sample in accordance with a predetermined sequence to obtain a mass analysis result for the measurement point or measurement area that the analysis operator specified.

The mass spectrometer according to the present invention may further include a memory unit for memorizing the sample surface image observed by the observation unit, and the specifier may be designed to be capable of specifying the measurement position or measurement area for which a mass analysis is performed by using the sample surface image read out from the memory unit.

As previously described, in the mass spectrometer according to the present invention, a matrix for MALDI can be applied only to the vicinity of the measurement point or measurement area. Therefore, after checking the mass analysis result for one measurement point or measurement area, the analysis operator can specify another measurement point or measurement area on the same sample to be mass analyzed. In this process, if a new measurement point or measurement area is specified by using the sample surface image memorized in the memory unit, there will be no need to bring back the sample to the observation position to perform an observation.

As an embodiment of the mass spectrometer according to the present invention, all of the observation position, the sample operation position, and the analysis position may be in an ambience of atmospheric pressure. With this configuration, the sample will always be under atmospheric pressure. Hence, an analysis can be performed while maintaining a good surface condition of an organic sample (e.g. while keeping the sample surface from drying or other problems).

As another embodiment of the mass spectrometer according to the present invention,

the observation position and the sample operation position may be in an ambience of atmospheric pressure and the analysis position may be in a vacuum; and

the mass spectrometer may include one or more preparatory chambers in which an ambience can be changed between an ambience of atmospheric pressure and a vacuum atmosphere or in which a gas pressure of the ambience is between the atmospheric pressure and the vacuum, on the way in which the sample holder is moved between the analysis position and either the observation position or the sample operation position.

With this configuration, an ionization by the MALDI or other method is performed under vacuum and a high level of ionization efficiency can be achieved. Therefore, as compared to an ionization by the atmospheric pressure MALDI or other method, an analysis can be performed with higher sensitivity. In addition, since one or more preparatory chambers are provided between the ambience of atmospheric pressure and the vacuum atmosphere, the vacuum chamber in which the ionization unit is installed can be maintained in a vacuum state when the sample is carried to the analysis position. Hence, an analysis can be efficiently performed.

### Effects of the Invention

With the mass spectrometer according to the present invention, the measurement point or measurement area for which a mass analysis is performed can be determined based on a clear surface image of a sample onto which a matrix is not yet applied. Hence, a measurement point or measurement area of interest can be accurately specified and a desired mass analysis result, material distribution image, and other results can be assuredly obtained.

Once the measurement point or measurement area is determined, there is no need to take out the sample to apply a matrix or digestive enzyme to the sample. This promotes the efficiency of the measurement operation itself. In addition, since no positional error of the sample occurs, a mass analysis for the exact measurement point or measurement area that the analysis operator specifies can be performed with high positional accuracy.

Moreover, since it is possible to attach the matrix only onto the vicinity of the measurement point or measurement area on the sample, a remeasurement can be easily performed after the application conditions of the matrix, the kind of the matrix, or other factor is changed in response to the mass analysis result for example. In this manner, measurements using the same sample a plurality of times can be easily performed. This leads to an efficient use of a precious sample, and simultaneously leads to the reduction in the running cost of the measurement.

### BRIEF DESCRIPTION OF THE DRAWINGS

FIG. 1 is an overall configuration diagram of a mass microscope according to the first embodiment of the present invention.

FIG. 2 is an overall configuration diagram of a mass microscope according to the second embodiment of the present invention.

FIG. 3 is an overall configuration diagram of a mass microscope according to the third embodiment of the present invention.

FIG. 4 is an overall configuration diagram of a mass microscope according to the fourth embodiment of the present invention.

### EXPLANATION OF NUMERALS

1 . . . Airtight Chamber
2 . . . Sample Stage
3 . . . Plate
4 . . . Sample
5 . . . Guide
7 . . . Imaging Unit
8 . . . Transmission Light Unit
9 . . . Matrix Ejector
10 . . . Laser Light Emitter
11 . . . Laser Condensing Optical System
20 . . . Vacuum Chamber
21 . . . Vacuum Pump
22 . . . Ion Transport Pipe
23 and 24 . . . Ion Transport Optical System
25 . . . Ion Trap
26 . . . Time-Of-Flight Mass Spectrometer
27 . . . Detector
30 . . . Data Processor
31 . . . Analysis Controller
32 . . . Controller
33 . . . Stage Driver
34 . . . Image Processor
35 . . . Ejection Driver
36 . . . Laser Driver
37 . . . Operation Unit
38 . . . Display Unit
40 . . . Atmospheric Pressure Chamber
41 . . . Preparatory Exhaust Chamber
42 and 43 . . . Partition Wall
44 . . . Partition Wall-Guide Driver
45 . . . Vacuum Chamber
A . . . Observation Position
B . . . Sample Operation Position
C . . . Analysis Position

### BEST MODE FOR CARRYING OUT THE INVENTION

### First Embodiment

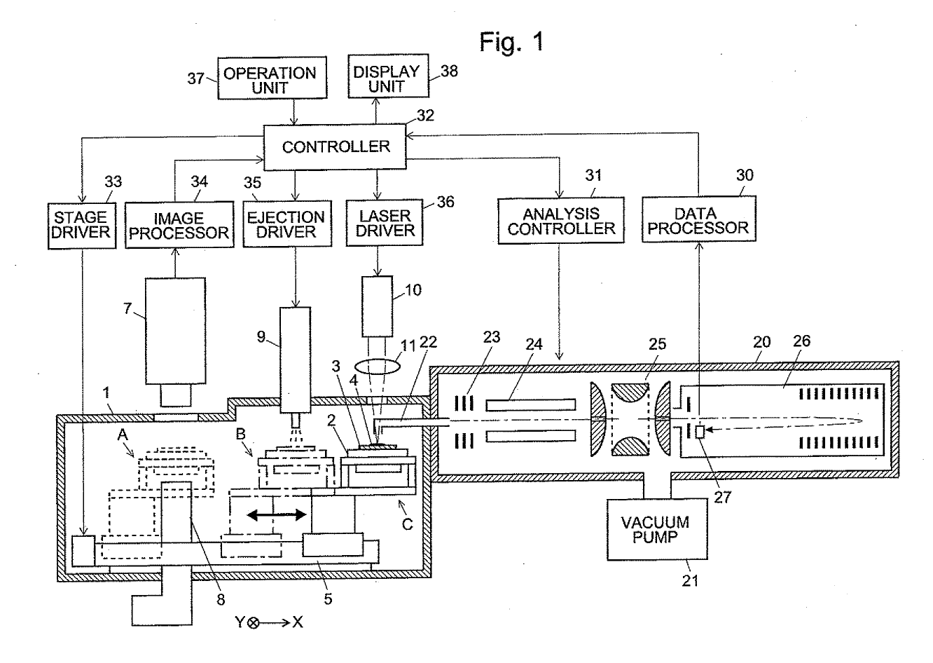

A mass microscope which is an embodiment (a first embodiment) of the mass spectrometer according to the present invention will be described with reference to FIG. 1. FIG. 1 is an overall configuration diagram of the mass microscope according to the first embodiment.

This mass microscope includes an airtight chamber 1 inside of which is maintained in an approximately atmospheric pressure and a vacuum chamber 20 inside of which is maintained at a high vacuum atmosphere by a vacuum pump 21 such as a turbo molecular pump. In the airtight chamber 1, a sample stage 2 for holding a plate 3 on which a sample 4 is placed is provided in such a manner that the sample stage 2 can reciprocally slide in the X-direction along a guide 5. In FIG. 1, the position C where the sample stage 2 is shown with solid lines is the analysis position, the position A with dashed lines is the observation position, and the position B with alternate long and short dash lines is the sample operation position. By a driving mechanism (not shown) including a motor and other parts, the sample stage 2 can be moved within a predetermined range not only in the X-direction along the guide 5, but also in the Y-direction, which is horizontally orthogonal to the X-direction, and in the height direction, i.e. Z-direction.

An imaging unit 7 such as a charge coupled device (CCD) camera is provided outside the airtight chamber 1, over the observation position A. A transmission lighting unit 8 is provided inside the airtight chamber 1 in such a manner as to face the imaging unit 7. When the sample stage 2 is at the observation position A, a light emitted from the transmission lighting unit 8 illuminates the lower surface of the sample 4 through an opening formed in the sample stage 2, so that the a sample image formed by the transmitted light can be observed by the imaging unit 7. The imaging unit 7, which serves as the observation unit in the present invention, is designed to be capable of performing a magnifying observation or a microscopic observation. The image signals obtained by the imaging unit 7 are sent to an image processor 34, which processes those image signals to form a two-dimensional surface image that can be displayed in a display unit 38 which will be described later. In addition to such a lighting unit for transmission observation, a lighting unit for reflection observation or fluorescence observation may also be provided as a matter of course. In place of the imaging unit 7, an optical microscope which an analysis operator can directly look in may be used for a microscopic observation of the sample 4.

A matrix ejector 9 having a microscopic nozzle for ejecting a matrix is provided over the sample operation position B. The matrix ejector 9 is driven by an ejection driver 35 and capable of applying a matrix at any position on the sample 4.

A laser light emitter 10 and a laser condensing optical system 11 are provided over the analysis position C, outside the airtight chamber 1, in order to provide a laser light with a micro diameter onto the surface of the sample 4. In the airtight chamber 1, an ion collection opening of an ion transport pipe 22 faces the sample 4 to transport ions generated from the sample 4 in response to an irradiation with the laser light.

The airtight chamber 20 contains the following devices: an ion transport optical systems 23 and 24 for sending ions into the subsequent stage while converging them; an ion trap 25 for temporarily storing ions; a reflectron time-of-flight mass spectrometer 26 for separating ions in accordance with their mass-to-charge ratio (m/z); and a detector 27 for detecting ions separated in the time-of-flight mass spectrometer 26. The ion trap 25 is capable of not only holding ions but also selecting ions having a specific mass-to-charge ratio among a variety of introduced ions as precursor ions and dissociating them by a collision induced dissociation to generate product ions. Hence, this mass microscope can perform an MS/MS analysis or an MSⁿ analysis, in addition to a normal (i.e. without a dissociation operation) mass analysis.

The detection signal produced by the detector 27 is sent to a data processor 30, where the flight time of each ion is converted into a mass-to-charge charge ratio to create a mass spectrum. One mass spectrum is obtained for each of the different measurement points within the measurement area. Then, then a mapping image showing the distribution of ions having a specific mass-to-charge ratio or other information is created based on the obtained mass spectra.

The controller 32 for managing the overall control of the mass microscope controls the operation of a mass analyzer such as the ion trap 25 through an analysis controller 31, the movement of the sample stage 2 with the drive unit (not shown) through a stage driver 33, the emission of a laser light from the laser light emitter 10 through a laser driver 36, and the ejection of matrix to the sample 4 through the ejection driver 35. An operation unit 37 for allowing an analysis operator to enter an operation or direction and a display unit 38 for displaying a two-dimensional observation image of the sample 4, a two-dimensional material distribution image as a mass analysis result, or other data are connected to the controller 32.

At least a portion of the functions of the controller 32, the analysis controller 31, and the data processor 30 can be realized by executing dedicated software installed in a personal computer.

An example of the procedure of a measurement using the mass microscope according to the first embodiment will be described.

The analysis operator first places the sample 4 to be measured on the plate 3 outside the airtight chamber 1, and sets the plate 3 on the sample stage 2. Then, when the analysis operator enters an instruction for performing a microscopic observation through the operation unit 37, the controller 32 receives the instruction and moves the sample stage 2 to the observation position A through the stage driver 33. When the sample stage 2 reaches the observation position A, the imaging unit 7 focuses on the sample 4 at an indicated magnification and takes a surface observation image of the sample 4 on the sample stage 2. The controller 32 displays the magnified image of the surface of the sample 4 created by the image processor 34 on a window of the display unit 38.

At this point in time, the observation image is displayed on the display unit 38 as a real-time image. Looking at the observation image, the analysis operator performs an operation through the operation unit 37 to change the observation magnification and/or move the sample stage 2 so that an observation image of an appropriate two-dimensional area on the sample 4 is displayed. In this manner, the analysis operator determines one or more measurement points or measurement areas to be analyzed on the sample 4, and specifies the points or areas through the operation unit 37. For example, the measurement point or measurement area can be specified by moving a cursor to a desired position and performing a click operation or by encompassing a desired area on the magnified image of the sample 4 displayed on the display unit 38. The specified measurement point or measurement area is memorized in the controller 32 as a coordinate position on the sample stage 2. The observation image used for determining the measurement point or measurement area is memorized in an image memory unit (not shown) included in the controller 32.

When the measurement point or measurement area is determined, the controller 32 moves the sample stage 2 to the sample operation position 13 through the stage driver 33. After the sample stage 2 is moved to the sample operation position B, the controller 32 further adjusts the position of the sample stage 2 in the X-direction and Y-direction and also adjusts its position in the Z-direction to optimize the height in order that a matrix is applied to the measurement point or measurement area which was previously memorized as a coordinate position. Then, the controller 32 controls the ejection driver 35 so that an appropriate amount of matrix is ejected from the matrix ejector 9 to the sample 4. Consequently, the matrix is applied to the predetermined position on the surface of the sample 4. When the matrix is to be applied to a certain amount of measurement area, the sample stage 2 may be minutely moved in the X-direction and Y-direction while the matrix is continuously or intermittently ejected from the matrix ejector 9.

The position of the sample 4 on the sample stage 2 in ejecting the matrix is not different at all from that in determining the measurement point or measurement area. Accordingly, it is possible to apply a matrix to the measurement point or measurement area specified by the analysis operator with high accuracy. Conversely, since the matrix is not attached to any area other than the measurement point or measurement area, the surface of the sample 4 can be kept in a good condition.

Then, the controller 32 moves the sample stage 2 from the sample operation position 13 to the analysis position C through the stage driver 33. After the sample stage 2 is moved to the analysis position C, the controller 32 finely adjusts the position of the sample stage 2 in the X-direction and the Y-direction, and also adjusts in the Z-direction to the optimum height so that a laser light will be delivered to the measurement area or the first measurement point in the measurement area which was previously memorized as the coordinate position. Then, the controller 32 controls the laser light emitter 36 through the laser driver 36 so as to emit a laser light for a short period of time, so that the laser light is delivered onto the intended measurement point on the sample 4.

The delivered laser light ionizes the components in the sample 4. The generated ions are drawn into the ion collection opening of the ion transport pipe 22, through which they are introduced into the vacuum chamber 20. The ions are introduced into the ion trap 25 through the ion transport optical systems 23 and 24. After a cooling or other type of operation is performed in the ion trap 25, a kinetic energy is given to the ions almost collectively and the ions are sent into the time-of-flight mass spectrometer 26. Generally, in the MALDI, the number of ions generated by one irradiation with laser light is not that large, and the amount of generated ions varies significantly. Given these factors, a pulsed laser light is delivered a plurality of times onto the same measurement point, and the ions generated by each irradiation are temporarily stored in the ion trap 25. Then, the ions are collectively mass analyzed in the time-of-flight mass spectrometer 26.

The ions collectively ejected from the ion trap 25 are separated in accordance with their mass-to-charge ratio during their flight in the time-of-flight mass spectrometer 26, and reach the detector 27 at different points in time. The detector 27 provides a detection signal corresponding to the amount of incident ions and the detection signal is sent to the data processor 30. Since the flight time of each ion corresponds to its mass-to-charge ratio, the data processor 30 converts the flight time into the mass-to-charge ratio to create a mass spectrum.

In performing measurements for a plurality of measurement points on the sample 4, the controller 32 controls the driving mechanism through the stage driver 33 in such a manner that a laser light is sequentially delivered to the plurality of measurement points. In performing a measurement for a predetermined measurement area on the sample 4, the controller 32 controls the driving mechanism through the stage driver 33 in such a manner that the irradiation position of the laser light is sequentially moved in the X-direction and Y-direction by a predetermined step width in the area. By performing the mass analysis as previously described while changing the scanning position of the delivered laser light, the data processor 30 creates a mass spectrum for each measurement point. In addition, the data processor 30 performs a qualitative or quantitative analysis based on these mass spectra to identify the substance or deduce the content thereof.

In mass analyzing a predetermined measurement area on the sample 4, the signal intensity of a specific mass-to-charge ratio is obtained every time a laser irradiation position is changed as previously described. By producing a two-dimensional image from the signal intensities, a distribution image of a specified material can be created. The controller 32 displays the mass analysis result obtained in the manner as just described on a window of the display unit 38. After the mass analysis for the specified measurement point or measurement area is finished, the controller 32 moves the sample stage 2 to the observation position A through the stage driver 33 and terminates the series of measurements.

As previously described, in the mass microscope of the present embodiment, after the analysis operator sets the sample 4 on the sample stage 2 and determines a measurement point or measurement by using a clear observation image of the sample 4 to which a matrix is not yet attached, there is no need to take out the sample 4 from the sample stage 2. Therefore, a matrix is accurately attached (i.e. with high positional accuracy) to the measurement point or measurement area and the sample 4 is mass analyzed. This eliminates the inefficient operation of taking out the sample 4 and facilitates the automation of the process, leading to an improvement of the measurement efficiency. In addition, the sample 4 remains on the sample 4, which eliminates an error in the position of the sample 4 during a measurement. This is also advantageous in measuring a measurement point or measurement position of interest with high positional accuracy.

The determination of the measurement point or measurement area on the sample 4 can be performed prior to the application of the matrix. Hence, the observation image of the sample after the application of the matrix does not need to be clear. Therefore, a solid matrix (or a solution of a solid matrix) such as α-CHCA, DHB, or sinapinic acid can be used, with which the observation image after the application of the matrix tends to be unclear compared to the case where a liquid matrix is used. The use of a solid matrix facilitates achieving high spatial resolution.

In the measurement of the previous embodiment, the following operations are successively performed: a microscopic observation or a determination of the measurement point or measurement area at the observation position A; an application of the matrix at the sample operation position B; and a mass analysis at the analysis position C. As another example, after a matrix is applied to the sample 4, the sample stage 2 may be returned to the observation position A to take a microscopic image of the sample to which the matrix is applied.

The matrix is applied only to the vicinity of the measurement point or measurement area that was initially specified by the analysis operator. Hence, a different kind of matrix may be applied or a matrix may be applied with different application conditions to an area other than the measurement point or measurement area of the sample and then the sample may be mass analyzed. For example, after examining the mass analysis result obtained by the first measurement, the analysis operator changes the ejection condition of the matrix. Then, at the sample operation position B, the matrix is applied to a measurement point or measurement area different from that in the first measurement. After that, a mass analysis is performed by delivering a laser light to the measurement point or measurement area on the sample 4 at the analysis position C. Further, such a series of operations may be repeated.

The surface observation image of the sample 4 to which a matrix is not yet applied may be memorized in the image memory unit of the controller 32. In this case, for example, after the sample 4 to which a matrix has been applied at the sample operation position B is moved to the observation position A and a surface observation image is taken by the imaging unit 7, the obtained surface observation image can be compared to the previously memorized sample observation image of the sample to which the matrix was not yet applied.

In the aforementioned embodiment, a matrix for the ionization by the MALDI method is applied to the sample 4 at the sample operation position B. However, another type of pretreatment for ionizing the sample 4 may be performed at the sample operation position B. For example, when a biological tissue or other material is analyzed as a sample, an operation of applying a digestive enzyme for breaking down proteins into peptides may be performed at the sample operation position B. However, since breaking down proteins into peptides by a digestive enzyme takes some degree of time, the sample cannot be mass analyzed immediately after the digestive enzyme is applied thereto. Given this factor, a waiting position for keeping the sample after a digestive enzyme is applied and before a mass analysis is performed may be additionally provided, and a plurality of samples may be put at the waiting position. This increases the throughput of the analysis.

### Second Embodiment

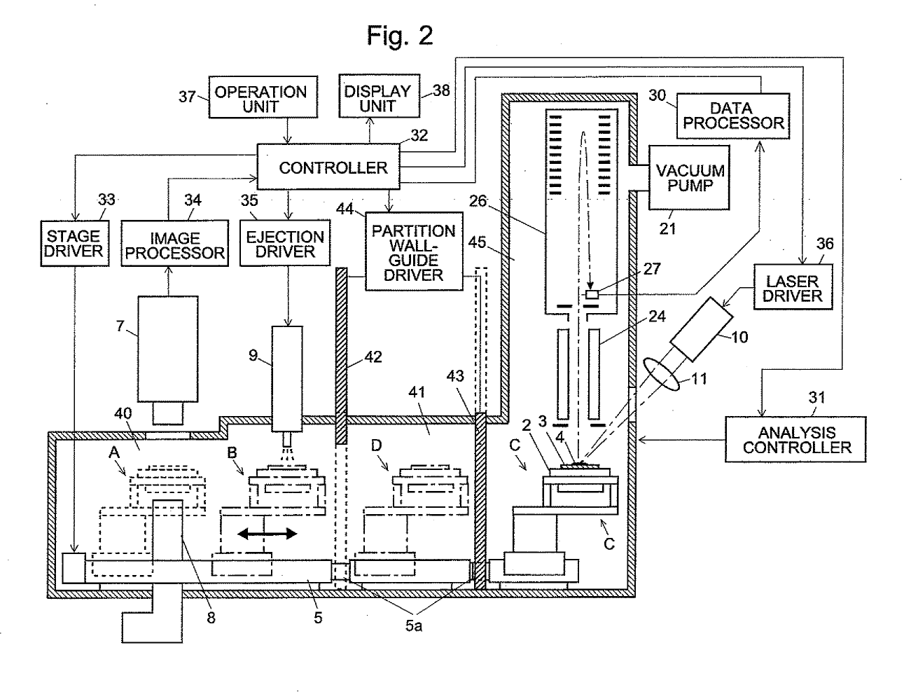

Next, a mass microscope according to another embodiment (a second embodiment) of the present invention will be described with reference to FIG. 2. FIG. 2 is an overall configuration diagram of the mass microscope of the second embodiment. The same components as in the first embodiment shown in FIG. 1 are indicated with the same numerals and the explanations are omitted.

In the mass microscope of the first embodiment, an ionization by the MALDI method is performed in the airtight chamber 1, i.e. under atmospheric pressure, whereas in the mass microscope of the second embodiment, an ionization by the MALDI method is performed in a vacuum atmosphere. That is, as opposed to the first embodiment in which the AP-MALDI is used, the mass microscope of the second embodiment uses the vacuum MALDI.

Even when the MALDI method is performed in a vacuum atmosphere, the operation of applying a matrix to the sample 4 must be performed under atmospheric pressure. In the case where a biological sample is used, it is preferable that a microscopic observation of the sample may also be performed under atmospheric pressure in order to prevent the sample from drying or other problems. Given this factor, in the mass microscope of the second embodiment, an preparatory exhaust chamber 41 is provided between the atmospheric chamber 40 in which the observation position A and the sample operation position B are provided and a vacuum chamber 45 in which the analysis position C and the mass analyzer such as a time-of-flight mass spectrometer 26 and other units are provided. The preparatory exhaust chamber 41 has a first partition wall 42 and a second partition wall 43 on both sides. Each of the two walls can be opened and closed.

When the second partition wall 43 is closed and the first partition wall 42 is opened by the controller 32 through a partition wall-guide driver 44, the preparatory exhaust chamber 41 communicates with the atmospheric chamber 40. On the other hand, when the first partition wall 42 is closed and the second partition wall 43 is opened, the preparatory exhaust chamber 41 communicates with the vacuum chamber 45. Portions of the guide 5 are designed to be a retractable guide 5a which is driven while interlocking with the partition wall 42 or 43. That is, when the partition wall 42 or 43 is opened, the corresponding guide 5a is pulled out to connect the guides of the two chambers across the partition wall, and when the partition wall 42 or 43 is closed, both guides 5a are withdrawn so as not to impede the closing operation. Of course, the guide 5 may have another structure such as a bending mechanism other than the retractable mechanism.

In the mass microscope of the second embodiment, after a matrix is applied to the sample 4 at the sample operation position B, the sample stage 2 is moved to an preparatory position D. In this state, both of the partition walls 42 and 43 are closed and the preparatory exhaust chamber 41 is sealed. Then, the inside of the preparatory exhaust chamber 41 is vacuum-evacuated by a vacuum pump (not shown). When the degree of vacuum is increased to some extent, the second partition wall 43 is opened and the sample stage 2 is moved to the analysis position C. Since the internal space of the preparatory exhaust chamber 41 is sufficiently small compared to the vacuum chamber 45, the process of evacuating the preparatory exhaust chamber 41 from the atmospheric pressure state to the vacuum state requires only a short period of time. Therefore, the time required for a measurement can be reduced compared to the case where the vacuum state of the vacuum chamber 45 needs to be broken to move the sample stage 2 to the analysis position C.

### Third Embodiment

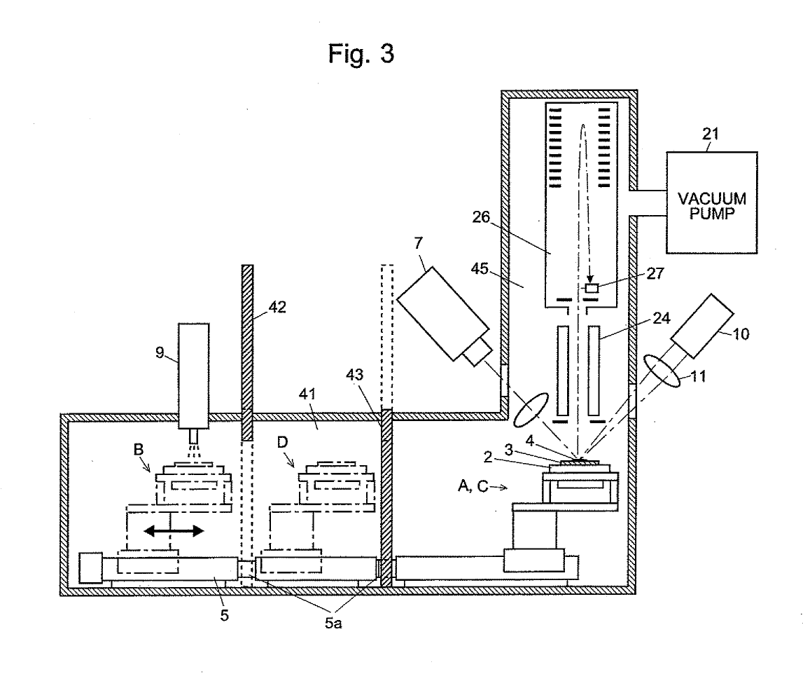

A mass microscope according to another embodiment (a third embodiment) of the present invention will be described with reference to FIG. 3. FIG. 3 is an overall configuration diagram of the mass microscope of the third embodiment. The explanations for the control system and signal processing system are omitted.

In the second embodiment, the analysis position C where a laser light is delivered to the sample 4 and the observation position A where the sampler 4 is observed are located at different positions. In the MALDI mass microscope of the third embodiment, the analysis position C and the observation position A are the same. That is, while the laser light emitted from the laser emitter 10 is being delivered to the sample 4, the surface observation image of the sample 4 can be taken by the imaging unit 7. The operation of analyzing a target sample is basically the same as in the second embodiment.

### Fourth Embodiment

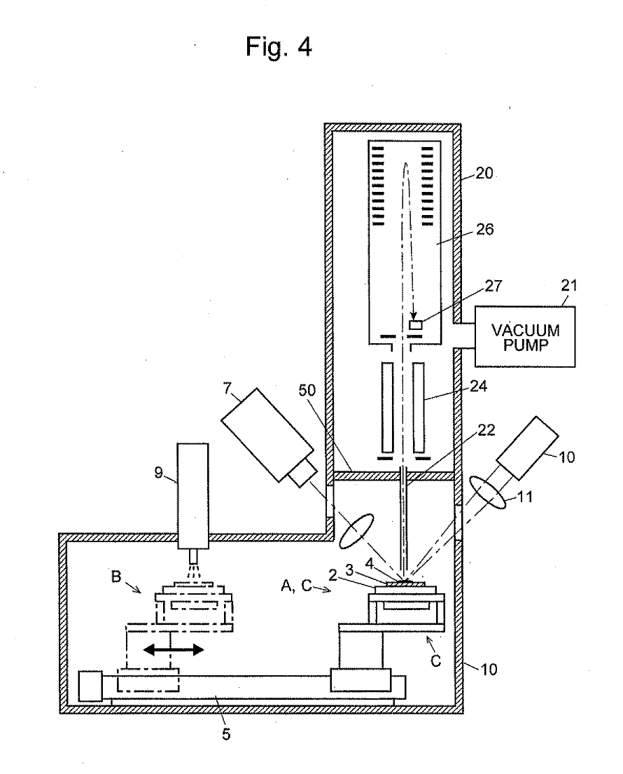

A mass microscope according to another embodiment (a fourth embodiment) of the present invention will be described with reference to FIG. 4. FIG. 4 is an overall configuration diagram of the mass microscope of the fourth embodiment. As in FIG. 3, the explanations for the control system and signal processing system are omitted.

In the first embodiment, the analysis position C where a laser light is delivered to the sample 4 and the observation position A where the sample 4 is observed are separated from each other. In the MALDI mass microscope of the fourth embodiment, the analysis position C and the observation position A are the same. That is, while the laser light emitted from the laser emitter 10 is being delivered to the sample 4, the surface observation image of the sample 4 can be taken by the imaging unit 7. The operation of analyzing a target sample is basically the same as in the first embodiment.

It should be noted that the embodiment described thus far is merely an example of the present invention, and it is evident that any modification, adjustment, or addition appropriately made within the spirit of the present invention is also included in the scope of the claims of the present application.

1. A mass spectrometer comprising:
a) a sample holder for holding a sample;
b) an observation unit for observing a surface of the sample held by the sample holder;
c) an ionization unit for ionizing a component at a specified position on the sample held by the sample holder;
d) a mass analyzer for mass analyzing an ion generated by the ionization unit;
e) a pretreatment unit for performing a pretreatment operation, to the sample, for making the sample held by the sample holder ready to be ionized by the ionization unit;
f) a moving unit for moving the sample holder in such a manner that the sample is sequentially carried to an observation position where the sample can be observed by the observation unit, a sample operation position where the pretreatment operation can be performed, and an analysis position where an ionization can be performed by the ionization unit;
g) a specifier for allowing an operator to specify a position or area for which a mass analysis is performed on a sample surface image observed by the observation unit; and
h) a controller for controlling the moving unit in such a manner that the pretreatment operation is performed for the position or area on the sample specified by the specifier and that the position or area is mass analyzed.

2. (canceled)

3. The mass spectrometer according to claim 1, further comprising:
a memory unit for memorizing the sample surface image observed by the observation unit, wherein:
the specifier, in allowing the operator to specify the position or area, uses the sample surface image read out from the memory unit.

4. The mass spectrometer according to claim 1, wherein:
the ionization unit performs a matrix-assisted laser desorption ionization; and
the pretreatment unit performs a pretreatment operation in which a matrix is applied to a surface of the sample.

5. The mass spectrometer according to claim 1, wherein:
the pretreatment unit performs a pretreatment operation in which a digestive enzyme is applied to a protein sample.

6. The mass spectrometer according to claim 1, wherein:
all of the observation position, the sample operation position, and the analysis position are in an ambience of atmospheric pressure.

7. The mass spectrometer according to claim 1, wherein:
the observation position and the sample operation position are in an ambience of atmospheric pressure and the analysis position is in a vacuum; and
the mass spectrometer comprises one or more preparatory chambers in which an ambience can be changed between an ambience of atmospheric pressure and a vacuum atmosphere or in which a gas pressure of the ambience is between the atmospheric pressure and the vacuum, on a way in which the sample holder is moved between the analysis position and either the observation position or the sample operation position.

8. The mass spectrometer according to claim 3, wherein:
the ionization unit performs a matrix-assisted laser desorption ionization; and
the pretreatment unit performs a pretreatment operation in which a matrix is applied to a surface of the sample.

9. The mass spectrometer according to claim 3, wherein:
the pretreatment unit performs a pretreatment operation in which a digestive enzyme is applied to a protein sample.

10. The mass spectrometer according to claim 3, wherein:
all of the observation position, the sample operation position, and the analysis position are in an ambience of atmospheric pressure.

11. The mass spectrometer according to claim 4, wherein:
all of the observation position, the sample operation position, and the analysis position are in an ambience of atmospheric pressure.

12. The mass spectrometer according to claim 5, wherein:
all of the observation position, the sample operation position, and the analysis position are in an ambience of atmospheric pressure.

13. The mass spectrometer according to claim 8, wherein:
all of the observation position, the sample operation position, and the analysis position are in an ambience of atmospheric pressure.

14. The mass spectrometer according to claim 9, wherein:
all of the observation position, the sample operation position, and the analysis position are in an ambience of atmospheric pressure.

15. The mass spectrometer according to claim 3, wherein:
the observation position and the sample operation position are in an ambience of atmospheric pressure and the analysis position is in a vacuum; and
the mass spectrometer comprises one or more preparatory chambers in which an ambience can be changed between an ambience of atmospheric pressure and a vacuum atmosphere or in which a gas pressure of the ambience is between the atmospheric pressure and the vacuum, on a way in which the sample holder is moved between the analysis position and either the observation position or the sample operation position.

16. The mass spectrometer according to claim 4, wherein:
the observation position and the sample operation position are in an ambience of atmospheric pressure and the analysis position is in a vacuum; and
the mass spectrometer comprises one or more preparatory chambers in which an ambience can be changed between an ambience of atmospheric pressure and a vacuum atmosphere or in which a gas pressure of the ambience is between the atmospheric pressure and the vacuum, on a way in which the sample holder is moved between the analysis position and either the observation position or the sample operation position.

17. The mass spectrometer according to claim 5, wherein:
the observation position and the sample operation position are in an ambience of atmospheric pressure and the analysis position is in a vacuum; and
the mass spectrometer comprises one or more preparatory chambers in which an ambience can be changed between an ambience of atmospheric pressure and a vacuum atmosphere or in which a gas pressure of the ambience is between the atmospheric pressure and the vacuum, on a way in which the sample holder is moved between the analysis position and either the observation position or the sample operation position.

18. The mass spectrometer according to claim 8, wherein:
the observation position and the sample operation position are in an ambience of atmospheric pressure and the analysis position is in a vacuum; and
the mass spectrometer comprises one or more preparatory chambers in which an ambience can be changed between an ambience of atmospheric pressure and a vacuum atmosphere or in which a gas pressure of the ambience is between the atmospheric pressure and the vacuum, on a way in which the sample holder is moved between the analysis position and either the observation position or the sample operation position.

19. The mass spectrometer according to claim 9, wherein:
the observation position and the sample operation position are in an ambience of atmospheric pressure and the analysis position is in a vacuum; and
the mass spectrometer comprises one or more preparatory chambers in which an ambience can be changed between an ambience of, atmospheric pressure and a vacuum atmosphere or in which a gas pressure of the ambience is between the atmospheric pressure and the vacuum, on a way in which the sample holder is moved between the analysis position and either the observation position or the sample operation position.
